(19) United States
(12) Patent Application Publication
(10) Pub. No.: US 2026/0169638 A1
(43) Pub. Date: Jun. 18, 2026

(54) ELECTRONIC DEVICE AND METHOD FOR ADAPTIVELY STORING DATA IN BUNDLE FORM

(71) Applicant: KOREA AEROSPACE RESEARCH INSTITUTE, Daejeon (KR)

(72) Inventor: Huiung PARK, Daejeon (KR)

(73) Assignee: KOREA AEROSPACE RESEARCH INSTITUTE, Daejeon (KR)

(21) Appl. No.: 19/404,298

(22) Filed: Dec. 1, 2025

(30) Foreign Application Priority Data
Dec. 17, 2024 (KR) 10-2024-0188479

(51) Int. Cl. G06F 3/06; G01W 1/10

(52) U.S. Cl. CPC G06F 3/0619; G01W 1/10; G06F 3/0646; G06F 3/067

(57) ABSTRACT

An electronic device and method for adaptively storing data in bundle form. An aspect of the present disclosure provides an electronic device comprising: a processor; a memory storing instructions; a first storage storing data; and a second storage having a radiation tolerance higher than that of the first storage, wherein, when executed by the processor, the instructions cause the electronic device to transfer data stored in the first storage to the second storage when a deterioration of a space weather environment of a region of space in which the electronic device is located occurs, and to transfer data stored in the second storage to the first storage when the deterioration of the space weather environment is resolved, and wherein the data stored in the first storage or the data stored in the second storage is data that is transmitted to another electronic device via space communications in bundle form.

### CROSS-REFERENCE TO RELATED APPLICATION

This application claims the benefit of and priority to Korean Patent Application No. 10-2024-0188479, filed on Dec. 17, 2024, the entire disclosure(s) of which is hereby incorporated herein by reference in its entirety.

### TECHNICAL FIELD

The present disclosure relates to an electronic device and method for adaptively storing data in bundle form.

### BACKGROUND

The statements in this section merely provide background information related to the present disclosure and do not necessarily constitute prior art.

During communication in space, long delays or intermittent communication interruptions may occur due to the extreme communication environment of space. In order to overcome the constraints of the space communications environment, Delay Tolerant Networking (DTN) technology, which stores and then transmits data, may be used. In delay tolerant networking technology, data in the form of bundles, which are a type of data packet, may be used. When the bundle-form data is damaged due to effects such as solar wind and radiation in space, the accuracy of space communications may be degraded. To address this, research is actively being conducted on devices capable of storing and managing reliable bundle-form data even in extreme communication environments such as space communications environments.

### SUMMARY

An object of the present disclosure is to provide an electronic device and method for adaptively storing data in bundle form. Specifically, an object of the disclosure is to provide an electronic device and method for adaptively storing data in bundle form, in which, when a deterioration of the space weather environment occurs, data is transferred to a storage having high radiation tolerance, and when the deterioration of the space weather environment is resolved, the data is transferred to a storage having a relatively larger storage capacity per unit cost.

The technical objects of the present disclosure are not limited to those described above, and other technical objects not mentioned above may be understood clearly by those skilled in the art from the descriptions given below.

An embodiment of the present disclosure provides an electronic device comprising: a processor; a memory storing instructions; a first storage storing data; and a second storage having a radiation tolerance higher than that of the first storage, wherein, when executed by the processor, the instructions cause the electronic device to transfer data stored in the first storage to the second storage when a deterioration of a space weather environment of a region of space in which the electronic device is located occurs, and to transfer data stored in the second storage to the first storage when the deterioration of the space weather environment is resolved, and wherein the data stored in the first storage or the data stored in the second storage is data that is transmitted to another electronic device via space communications in bundle form.

Another embodiment of the present disclosure provides a method of operating an electronic device, the method comprising: transferring data stored in a first storage to a second storage having a radiation tolerance higher than that of the first storage, when a deterioration of a space weather environment of a region of space in which the electronic device is located occurs; and transferring data stored in the second storage to the first storage, when the deterioration of the space weather environment is resolved, and wherein the data stored in the first storage or the data stored in the second storage is data that is transmitted to another electronic device via space communications in bundle form.

According to an embodiment of the present disclosure, when a deterioration of the space weather environment occurs, data can be transferred to a storage for stably storing the data, thereby preventing data damage that may occur due to the deterioration of the space weather environment.

According to an embodiment of the present disclosure, when the deterioration of the space weather environment is resolved within an electronic device, pre-stored data and data being processed by a processor can be transferred back to a high-performance storage, thereby enabling data to be more efficiently stored.

The technical effects of the present disclosure are not limited to the technical effects described above, and other technical effects not mentioned herein may be understood to those skilled in the art to which the present disclosure belongs from the description below.

### BRIEF DESCRIPTION OF THE DRAWINGS

FIG. 1 is a diagram illustrating an electronic device for storing data in space according to one embodiment of the present disclosure.

FIG. 2 is a diagram illustrating an electronic device for storing data using a storage according to one embodiment of the present disclosure.

FIG. 3 is a diagram illustrating an electronic device for transferring data when a deterioration of space weather environment occurs, according to one embodiment of the present disclosure.

FIG. 4 is a diagram illustrating an electronic device for transferring data being processed by a processor to a storage when a deterioration of space weather environment occurs, according to one embodiment of the present disclosure.

FIG. 5 is a diagram illustrating an electronic device that enters a safe mode due to the occurrence of a deterioration of space weather environment, according to one embodiment of the present disclosure.

FIG. 6 is a diagram illustrating an electronic device for transferring data for suspended bundle processing to a processor when a deterioration of space weather environment is resolved according to one embodiment of the present disclosure.

FIG. 7 is a diagram illustrating an electronic device for transferring data when a deterioration of space weather environment is resolved according to one embodiment of the present disclosure.

FIG. 8 is a diagram showing a method of operating an electronic device according to one embodiment of the present disclosure.

FIG. 9 is a diagram illustrating a storage policy according to one embodiment of the present disclosure.

FIG. 10 is a diagram showing an electronic device according to one embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

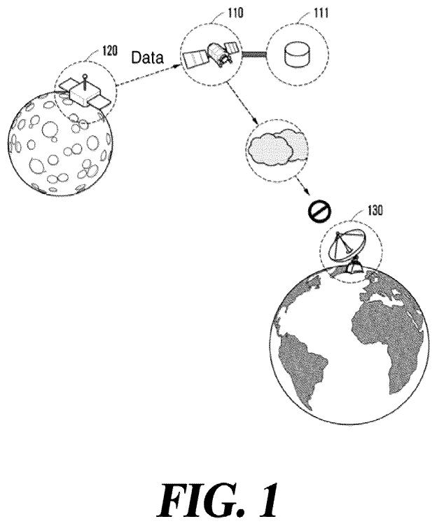

FIG. 1 is a diagram illustrating an electronic device for storing data in space according to one embodiment of the present disclosure.

Referring to FIG. 1, an example is illustrated for explaining a process in which an electronic device 110 located in space transmits data between a device 120 located on a planet and a device 130 located on Earth.

The electronic device 110 may perform a role of transmitting and receiving data between the device 120 located on the planet and the device 130 located on Earth. Due to a distance between the device 120 located on the planet and the device 130 located on Earth, a long delay time or intermittent communication interruption may occur in the process of transmitting and receiving the data. In order to prevent data loss caused by delay time or intermittent communication interruption, a delay tolerant networking (DTN) technology may be used, in which data is stored in a storage 111 of the electronic device 110 and then transmitted. The electronic device 110 may include the storage 111 for storing data. When the data is stored in the storage 111, the data may be stored in a bundle form so as to transmit the data more efficiently. The storage 111 may include a commercial off-the-shelf (COTS) storage having high performance, low cost, and low stability, or a space-grade storage having low performance, high cost, and high stability. Hereinafter, the commercial off-the-shelf storage may be referred to as a high-performance storage, and the space-grade storage may be referred to as a high-reliability storage.

Herein, the high-reliability storage refers to a high-reliability storage designed for use in space. The high-reliability storage may include a storage having radiation hardness. The high-reliability storage may be a storage having a higher radiation tolerance compared to that of the high-performance storage. Here, the radiation tolerance refers to a property in which damage or performance degradation occurs less even when exposed to radiation. For example, the high-reliability storage may include a storage whose radiation tolerance is assured through Radiation Hardness Assurance (RHA). Here, RHA refers to a procedure for testing and assuring that satellite electronic components maintain normal performance in a space radiation environment. It establishes a requirement value for each item such as Total Ionizing Dose (TID) or Single Event Effects (SEE), and verifies conformity to such a requirement value. The high-reliability storage has higher radiation tolerance, thereby experiencing relatively fewer errors or damage caused by space radiation compared to the high-performance storage, and can maintain data integrity even under extreme temperatures or vibrations. However, the storage capacity or storage speed of the high-reliability storage may be relatively lower than that of the high-performance storage. In this specification, the storage having high radiation tolerance may be referred to as a high-stability storage.

Herein, the high-performance storage refers to a large-capacity and high-speed storage implemented with commercial off-the-shelf (COTS) technology. For example, the high-performance storage may include a high-speed solid state drive (SSD) or a high-capacity flash memory. The high-performance storage may have a higher processing speed compared to the high-reliability storage, may have a relatively larger storage capacity, and may have a lower unit cost, thereby providing superior cost-performance. That is, the high-performance storage may have a relatively larger storage capacity per unit cost than that of the high-reliability storage. However, since the resistance to space radiation may not be sufficiently verified, malfunction or damage may occur due to Single Event Effects (SEE), and as a cumulative dose increases, there is a concern that it may lead to permanent failure. For example, the high-performance storage may malfunction at a Total Ionizing Dose (TID) of 5 krad or higher, and in some cases may fail even at a TID of 1 krad or less.

The high-reliability storage and the high-performance storage according to one embodiment of the present disclosure may be classified according to the assurance of Electrical, Electronic, and Electromechanical (EEE) parts in accordance with space standards and Radiation Hardness Assurance (RHA). Here, the assurance of the EEE parts is a system that defines the quality grades of electrical parts, electronic parts, and electromechanical parts used in satellites, and stipulates the management level of a manufacturing process, quality control procedures, and the level of traceability assurance. For example, the assurance of EEE parts includes performing part selection, screening, traceability assurance, and derating in accordance with relevant standards such as NASA-STD-8739.10/8739.11 or ECSS-Q-ST-60C.

The high-reliability storage according to one embodiment of the present disclosure may be a storage having a high level of EEE part assurance in accordance with space standards and having radiation tolerance assured through RHA. For example, the high-reliability storage may include a storage having an assurance level of 1 according to NASA-STD-8739.11, or a storage having an EEE part class of 1 according to ECSS-Q-ST-60C, but is not limited thereto.

The high-performance storage according to one embodiment of the present disclosure may be a storage having a low level of EEE part assurance or a storage whose radiation tolerance is not assured through the RHA. For example, the high-performance storage may include a storage having the assurance level of 4 according to NASA-STD-8739.11, or a storage having the EEE part class of 3 according to ECSS-Q-ST-60C, but is not limited thereto.

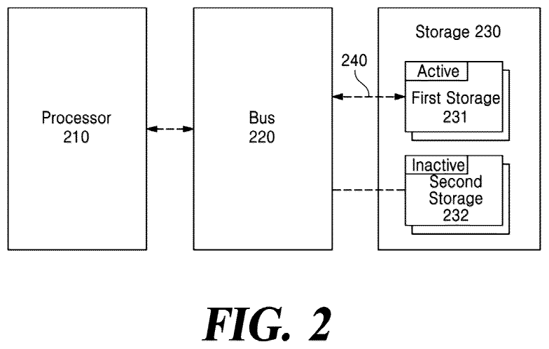

The electronic device 110 located in space may be exposed to a space weather environment 140 such as solar wind or radiation. The space weather environment 140 refers to a state of rapid change in the space environment caused by high-energy particle emissions due to solar activity, solar wind, or magnetic storm. The space weather environment 140 may be measured by a space weather forecasting alerting system on the ground or by a space weather sensor of the satellite itself. That is, the space weather environment 140 may be measured by the space weather forecasting alerting system external to the satellite or by the space weather sensor onboard the satellite. For example, the space weather forecasting alerting system may include the Space Weather Prediction Center (SWPC) under the National Oceanic and Atmospheric Administration (NOAA). The space weather environment 140 may deteriorate when the intensity of solar wind, radiation, or the like increases. The space weather environment 140 may be resolved when the intensity of solar wind, radiation, or the like decreases. When a deterioration of the space weather environment occurs, the data stored in the storage 111 of the electronic device 110 may be damaged. For example, as the intensity of radiation passing through the electronic device 110 increases, charge transfer caused by the radiation may occur in the storage 111 within the electronic device (110), and the data stored in the storage 111 may be distorted. A method by which the electronic device 110 can store data in space more cost-effectively and reliably despite the deterioration of the space weather environment, using the processor and the storage 111 including a commercial-grade storage and a space-grade storage, will be described in more detail with reference to FIGS. 2 to 7.

FIG. 2 is a diagram illustrating an electronic device for storing data using a storage according to one embodiment of the present disclosure.

Referring to FIG. 2, an operation in which a processor 210 stores data in a first storage 231 via a bus 220 is illustrated.

The storage 230 may store bundle-type data transferred from the processor 210. The storage 230 may include a first storage 231 and a second storage 232. To transmit data more efficiently in space where transmission delays or intermittent communication interruptions occur, the first storage 231 or the second storage 232 may store data to be transmitted to another electronic device via space communications in bundle form.

The first storage 231 has high performance and high capacity and is low in cost, but its stability may be reduced due to the deterioration of the space weather environment. For example, when the deterioration of the space weather environment occurs and thus the stability of the first storage 231 is reduced, bundle-type data stored in the first storage 231 may suffer damage such as bit errors.

The second storage 232 has low performance and low capacity and is high in cost, but its stability may be maintained even when the deterioration of the space weather environment occurs. The first storage 231 may have higher performance, lower cost, and lower stability than the second storage 232. Even when the space weather environment deteriorates, the data stored in the second storage 232 may remain undamaged.

When the deterioration of the space weather environment does not occur, the electronic device may store bundle-type data processed by the processor 210 in the first storage 231 via the bus 220. When the deterioration of the space weather environment does not occur, the second storage 232 may be deactivated and may not store the bundle-type data generated by the processor 210 due to its low capacity and low performance.

The bus 220 may operate as a communication path for efficiently transferring data between the processor 210 and the storage 230. The bus 220 may connect a plurality of storages through a single path to enhance the efficiency of data transfer between the processor 210 and the storage 230. For example, the bus 220 may perform a priority control function to alleviate bottlenecks that may occur between the processor 210 and the first storage 231 and the second storage 232 and to prevent data collisions.

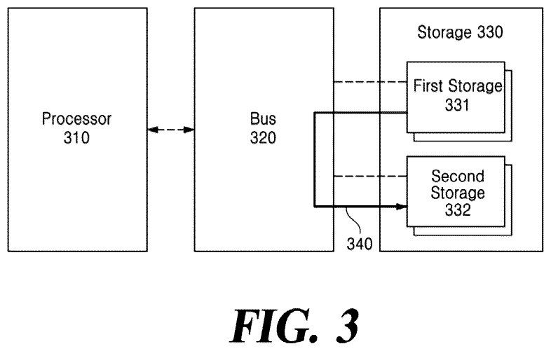

FIG. 3 is a diagram illustrating an electronic device for transferring data when a deterioration of space weather environment occurs, according to one embodiment of the present disclosure.

Referring to FIG. 3, when the deterioration of the space weather environment occurs, an operation in which data is transferred within the storage 330 is illustrated.

When the deterioration of the space weather environment occurs, the first storage 331 may have low stability as described above, and therefore the stored data may be damaged. For example, when the electronic device is exposed to strong radiation due to the deterioration of the space weather environment, bundle-type data stored in the first storage 331 may be damaged.

In operation 340, in order to prevent damage to data stored in the first storage 331, when a deterioration of the space weather environment occurs in the space where the electronic device is located, the electronic device may transfer the data stored in the first storage 331 to the second storage 332. For example, when a strong solar wind occurs and the electronic device has difficulty performing its normal mission, the electronic device may transfer the bundle-type data stored in the first storage 331 to the second storage 332. The deterioration of the space weather environment is not limited to the foregoing example, and may also include a case where data needs to be stored in the second storage 332, which has higher stability than the first storage 331, due to the possibility of space weather deterioration.

Since the second storage 332 may have a lower capacity than the first storage 331, the data stored in the first storage 331 may be larger than the capacity of the second storage 332. In one embodiment, the electronic device may sequentially transfer the data stored in the first storage 331 to the second storage 332 in order of the importance of the data. For example, when first data and second data, which is more important than the first data, are stored in the first storage 331, and the sum of the capacities the first and second data is larger than the capacity of the second storage 332, the electronic device may preferentially transfer the second data to the second storage 332.

When data may be damaged due to the occurrence of space weather deterioration, the electronic device may sequentially transfer the data stored in the first storage 331 to the second storage 332 in order of importance, thereby more efficiently preventing damage to important data.

Herein, the importance of data may be determined based on a user contract, a user mission characteristic, a data size, or a data type. For example, in satellite services, contract conditions may differ for each satellite service user, and data assigned a higher priority (e.g., priority class) according to the respective contract conditions may be transferred prior to data assigned a lower priority (e.g., economy class). In another example, the importance of data may be determined differently according to the characteristics of the satellite service user's mission (e.g., military mission, unmanned robotic exploration mission, or manned exploration mission). In another example, depending on the data size, small-sized data (e.g., navigation data, scientific data, telemetry, etc.) may be transferred prior to large-sized data (e.g., images, etc.). In another example, according to the data type, numerical scientific measurement data may be classified as first priority, image data as second priority, and video streams as third priority. These examples are provided for illustrative purposes only, and the criteria for determining data importance are not limited thereto. The importance of data according to one embodiment of the present disclosure may also be determined by a combination of multiple criteria.

The importance of data according to an embodiment of the present disclosure may be determined using a communication protocol. For example, according to the RFC 9171 bundle protocol, a bundle may include metadata in the form of an extension block in addition to user data. In one embodiment, a satellite service user may transmit data including importance information determined by the user to a satellite data provider. This method of determining the data importance is merely for helping understanding and is not limited thereto.

The importance of data according to one embodiment of the present disclosure may be determined by a satellite service provider or a satellite service user, but is not limited thereto.

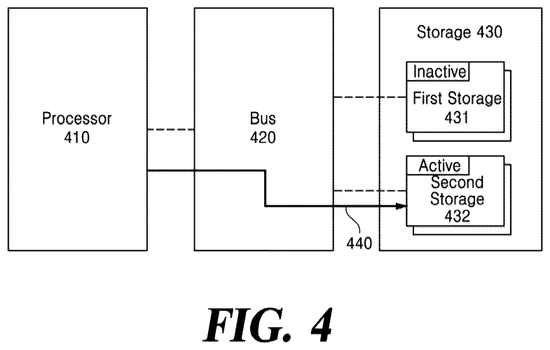

FIG. 4 is a diagram illustrating an electronic device for transferring data being processed by a processor to a storage when a deterioration of space weather environment occurs, according to one embodiment of the present disclosure.

Referring to FIG. 4, an operation in which a first storage 431 is deactivated and a second storage 432 is activated as the space weather environment deteriorates, so that data is stored in the second storage 432 is illustrated.

In the case of FIG. 3 described above, the bundle-type data stored in the first storage 431 is transferred to the second storage 432, but a processor 410 may still contain data being processed in the form of bundles. When the space weather environment deteriorates to the extent that the electronic device may not perform its normal mission, it may be necessary to take measures to prevent damage to data that has not yet been processed in bundle form in the processor 410 within the electronic device.

In operation 440, when space weather deterioration occurs, the electronic device may stop the bundle processing being performed by the processor 410 and transfer the data being processed in the processor 410 to the second storage 432, which has higher stability. The electronic device may transfer the data being processed in the processor 410 to the second storage 432 via the bus 420. As the data being processed in the processor 410 is transferred to the second storage 432, the stability of data that has not been stored in the first storage may be maintained even under deteriorated space weather conditions.

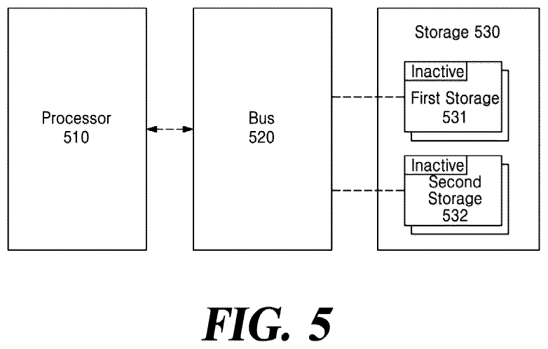

FIG. 5 is a diagram illustrating an electronic device that enters a safe mode due to the occurrence of a deterioration of space weather environment, according to one embodiment of the present disclosure.

Referring to FIG. 5, a process in which both a first storage 531 and a second storage 532 within a storage 530 are deactivated is illustrated.

As described above with reference to FIG. 3, due to the occurrence of a deterioration of space weather environment, the electronic device may transfer bundle-type data stored in the first storage 531 to the second storage 532 through a processor 510. As described above with reference to FIG. 4, due to the occurrence of a deterioration of space weather environment, the electronic device may stop the bundle processing being performed in the processor 510 and transfer the data being processed in the processor 510 to the second storage 532. When the data stored in the first storage 531 and the data being processed in the processor 510 are transferred to the second storage 532 due to the occurrence of a deterioration of space weather environment, the electronic device may enter the safe mode. When the electronic device enters the safe mode, the data being processed in the processor 510 may not pass through the bus 520, and all of the storages 530 may be deactivated. As the electronic device enters the safe mode, even if the space weather environment deteriorates for a long period of time, the data that needs to be stored may remain stored in the second storage 532 without being damaged.

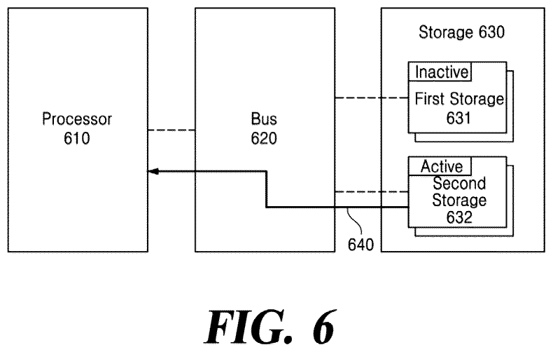

FIG. 6 is a diagram illustrating an electronic device for transferring data for suspended bundle processing to a processor when a deterioration of space weather environment is resolved according to one embodiment of the present disclosure.

After the electronic device enters the safe mode due to the deterioration of the space weather environment, the deterioration of the space weather environment may be resolved. In operation 640, when the space weather deterioration is resolved, the electronic device may transfer the data related to the bundle processing that was suspended due to the deterioration of the space weather environment from a second storage 632 to a processor 610. As the data related to the previously suspended bundle processing is transferred back to a processor 610 via a bus 620 without being damaged, the electronic device may perform bundle processing on undamaged data despite the deterioration of the space weather environment. The data transferred to the processor 610 undergoes bundle processing again, and the electronic device may transfer bundle-type data to a first storage 631 as described above with reference to FIG. 2.

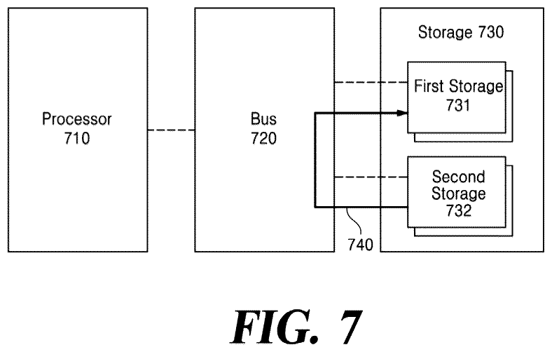

FIG. 7 is a diagram illustrating an electronic device for transferring data when a deterioration of space weather environment is resolved according to one embodiment of the present disclosure.

Referring to FIG. 7, when the space weather deterioration is resolved, an operation in which data is transferred within a storage 730 is illustrated.

Due to the deterioration of the space weather environment, as described above with reference to FIG. 3, data transferred from a first storage 731 may be stored in a second storage 732. When the deterioration of the space weather environment is resolved, the electronic device may transfer the data stored in the second storage 732 back to the first storage 731. The corresponding data may be in bundle form. Even if the deterioration of the space weather environment occurs and then is resolved, the data previously stored in the second storage 732 may be transferred to the first storage 731 without being damaged.

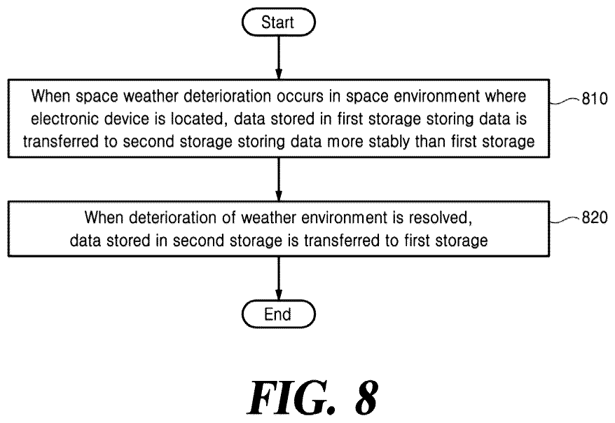

FIG. 8 is a diagram showing a method of operating an electronic device according to one embodiment of the present disclosure.

In the following embodiment, respective operations may be performed sequentially, but are not necessarily performed in that order. For example, the order of the operations may be changed, and at least two of the operations may be performed in parallel. The operations 810 and 820 may be performed by at least one component of the electronic device (e.g., memory, processor, etc.).

In operation 810, when space weather deterioration occurs in the space environment where the electronic device is located, the electronic device transfers the data stored in a first storage, which stores data, to a second storage that stores data more stably than the first storage. When space weather deterioration occurs, the electronic device may stop the bundle processing performed in the processor within the electronic device and transfer the data being processed in the processor to the second storage.

When the electronic device transfers the data stored in the first storage and the data being processed in the processor to the second storage due to the occurrence of the deterioration of space weather environment, it may enter a safe mode. The electronic device may transfer the data stored in the first storage to the second storage in order of importance. The first storage may have higher performance, lower cost, and lower stability than the second storage.

The data stored in the first storage or the second storage is transmitted to another electronic device via space communications in bundle form.

In operation 820, when the deterioration of space weather environment is resolved, the electronic device transfers the data stored in the second storage to the first storage. When the deterioration of space weather environment is resolved, the electronic device may transfer the data related to the bundle processing that was suspended due to the deterioration of space weather environment from the second storage to the processor within the electronic device. The first storage and the second storage may store data to be transmitted to another electronic device via space communications in bundle form.

As described in FIGS. 1 to 7, when the deterioration of space weather environment does not occur or is resolved, the electronic device may use the first storage to quickly store a larger amount of data, and when the deterioration of space weather environment occurs, it may use the second storage to prevent data damage. By using the first storage in some space weather environments, the cost of the electronic device can be reduced and the performance thereof can be improved

Since the matters described above with reference to FIGS. 1 to 7 are equally applicable to each operation illustrated in FIG. 8, a detailed description thereof will be omitted.

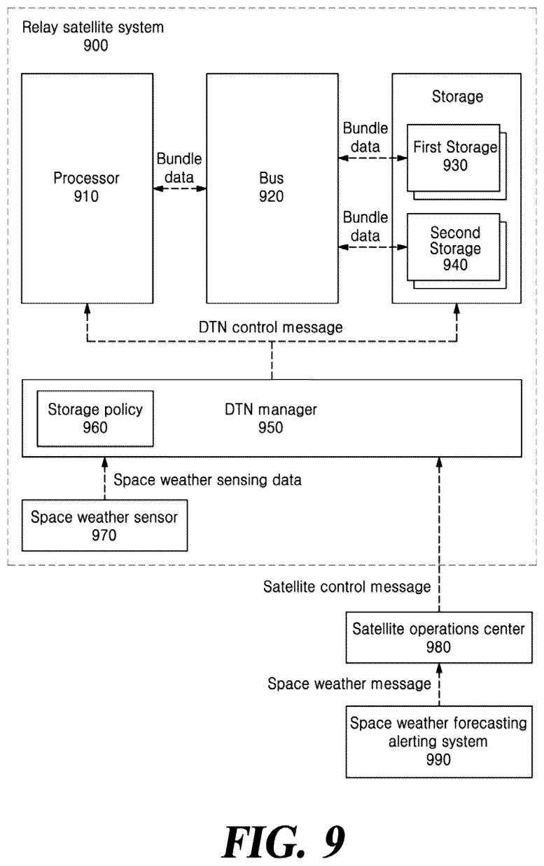

FIG. 9 is a diagram illustrating a storage policy according to one embodiment of the present disclosure.

Referring to FIG. 9, a relay satellite system 900 includes a processor 910, a bus 920, a first storage 930, a second storage 940, a DTN manager 950, and a space weather sensor 970.

The DTN manager 950 controls the selection of the first and second storages 930 and 940, data migration, and the switching of DTN operation modes based on a storage policy 960. The space weather sensor 970 measures space weather environment indicators, such as radiation dose and particle flux, in real time and provides them to the DTN manager 950.

The storage policy 960 may be classified into an autonomous storage policy, which autonomously determines the operation mode based on sensing data inside the relay satellite system 900, and a passive storage policy, which depends on external control from a satellite operations center (SOC) 980. The autonomous storage policy may determine the operation mode by integrating various indicators as well as space weather sensing data provided from the space weather sensor 970. For example, the autonomous storage policy may be established based on factors such as radiation intensity, satellite power supply level, and communication link performance. For example, the space weather sensor 970 may include a dose rate sensor or a PIN diode-based particle sensor, and the values measured from the space weather sensor 970 may include a dose rate or particle flux. The autonomous storage policy may operate to protect the satellite even in unexpected situations, such as delayed signal reception from the outside or sudden surges in radiation.

In one embodiment, the DTN manager 950 determines the following operation modes according to the autonomous storage policy:
(1) High-Performance Mode refers to an operational mode applied when the space weather environment is determined to be within a normal range. In the high-performance mode, bundle data are stored using a high-performance storage. In one embodiment, when the 10 MeV proton flux is less than 10 PFU, the DTN may operate in the high-performance mode. Here, PFU (Particle Flux Unit) is a unit of particle flux, defined as 1 PFU=1 proton/(cm² ·s·sr). For example, the NOAA SWPC classifies the intensity of solar particle storm based on the proton flux with energy greater than 10 MeV: an S1 level corresponds to 10 PFU or more, an S2 level corresponds to 100 PFU or more, and an S3 level corresponds to 1000 PFU or more. A larger PFU value indicates a greater number of high-energy particles reaching the satellite per unit time. As another example of the high-performance mode, when the 2 MeV electron flux is less than 1000 PFU, the DTN may operate in the high-performance mode. In another example, when a change in dose rate is within 20% of the normal level, the DTN may operate in the high-performance mode.

(2) High-Reliability Mode refers to a conservative operational state applied when precursors of an abnormal space weather environment are detected or when a mild disturbance occurs. In the high-reliability mode, bundle data are stored using a high-reliability storage. In one embodiment, when the 10 MeV proton flux is 10 PFU or more, the DTN may operate in the high-reliability mode. In another example, when the 2 MeV electron flux is 1000 PFU or more, the DTN may operate in the high-reliability mode. In another example, when a change in dose rate is two to five times higher than the normal level, the DTN may operate in the high-reliability mode.

(3) Safe Mode refers to a protective operational state applied when the space weather environment is determined to be in a hazardous condition (e.g., a high-risk storm or the like). In the safe mode, operations such as suspension of DTN services and power shutdown of non-essential equipment may be performed. That is, in the safe mode, the operation of the electronic device may be suspended, and, if necessary, the power supply to the high-performance storage and the high-reliability storage may be shut down. In one embodiment, when the 10 MeV proton flux is 1000 PFU or more, the DTN may operate in the safe mode. In another example, when the 2 MeV electron flux of 1000 PFU or more persists for a time exceeding a threshold, the DTN may operate in the safe mode. In still another example, when an instantaneous change in dose rate exceeds 0.1 rad/s, the DTN may operate in the safe mode.

The passive storage policy may include a configuration in which the SOC 980, having received a space weather message from the space weather forecasting alerting system 990, transmits a satellite control message to the DTN manager 950, and the DTN manager 950 determines an operation mode and a storage path based on the satellite control message.

In one embodiment of the passive storage policy, when the SOC 980 receives the space weather message from the space weather forecasting alerting system 990, such as the National Oceanic and Atmospheric Administration (NOAA), the SOC 980 may transmit a satellite control message instructing an operation mode switching to the DTN manager 950. For example, when the space weather forecasting alerting system 990 issues an S2-level solar particle storm alert, the SOC 980 may transmit a satellite control message to the DTN manager 950, instructing switching to the high-reliability mode. In another example, when the space weather forecasting alerting system 990 issues an S3-level solar particle storm alert, the SOC 980 may transmit a satellite control message to the DTN manager 950, instructing switching to the safe mode.

The storage policy 960 according to one embodiment of the present disclosure has been described by way of example as including the autonomous storage policy and the passive storage policy, but is not limited thereto. The storage policy 960 may include a policy in which the relay satellite system 900 directly receives a space weather message from the space weather forecasting alerting system 990 and determines an operation mode based thereon. In addition, the storage policy 960 may be configured by selectively combining all or part of the autonomous storage policy, the passive storage policy, and other storage policies. For example, by operating the autonomous storage policy and the passive storage policy in a complementary manner, it is possible to respond even to a deterioration of the space weather environment that the space weather forecasting alerting system 990 fails to predict in advance.

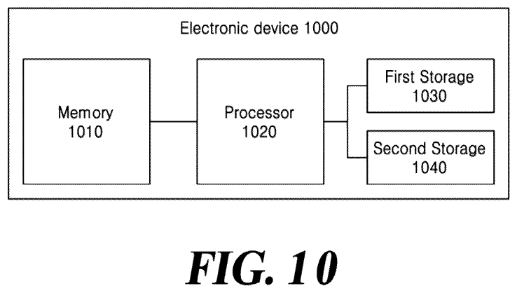

FIG. 10 is a diagram showing an electronic device according to one embodiment of the present disclosure.

Referring to FIG. 10, an electronic device 1000 includes a memory 1010, a processor 1020, a first storage 1030, and a second storage 1040. The memory 1010 and the processor 1020 may communicate with each other through a bus, PCIe (Peripheral Component Interconnect Express), and/or a NoC (Network on a Chip).

The memory 1010 may include computer-readable instructions. As at least one of the instructions stored in the memory 1010 is executed by one or more processors 1020, the electronic device 1000 may be caused to perform the operations described above. The memory 1010 may be a volatile memory or a non-volatile memory.

The processor 1020 is a device that executes instructions or programs or controls the electronic device 1000, and may include, for example, a CPU (Central Processing Unit) and/or a GPU (Graphics Processing Unit).

The electronic device 1000 includes the processor 1020, the memory 1010 that stores instructions, the first storage 1030 that stores data, and the second storage 1040 that stores data more stably than the first storage 1030.

When executed by the processor 1020, the instructions cause the electronic device 1000 to transfer data stored in the first storage 1030 to the second storage 1040 when a deterioration of the space weather environment of the region of space in which the electronic device 1000 is located occurs, and to transfer the data stored in the second storage 1040 back to the first storage 1030 when the deterioration of the space weather environment is resolved.

The data stored in the first storage 1030 or the second storage 1040 is transmitted to another electronic device via space communications in bundle form.

Other operations of the electronic device 1000 may be applied in the same manner as previously described.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium”.

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed:

1. An electronic device comprising:
a processor;
a memory storing instructions;
a first storage storing data; and
a second storage having a radiation tolerance higher than that of the first storage,
wherein, when executed by the processor, the instructions cause the electronic device to transfer data stored in the first storage to the second storage when a deterioration of a space weather environment of a region of space in which the electronic device is located occurs, and to transfer data stored in the second storage to the first storage when the deterioration of the space weather environment is resolved, and
wherein the data stored in the first storage or the data stored in the second storage is data that is transmitted to another electronic device via space communications in bundle form.

2. The electronic device of claim 1, wherein, when executed by the processor, the instructions cause the electronic device to suspend bundle processing performed by the processor and to transfer data being processed by the processor to the second storage, when the deterioration of the space weather environment occurs.

3. The electronic device of claim 2, wherein, when executed by the processor, the instructions cause the electronic device to enter a safe mode in which the operation of the electronic device is suspended when, due to the occurrence of the deterioration of the space weather environment, the data stored in the first storage and the data being processed by the processor have been transferred to the second storage.

4. The electronic device of claim 1, wherein, when executed by the processor, the instructions cause the electronic device to transfer the data stored in the first storage to the second storage in order of importance.

5. The electronic device of claim 4, wherein the importance is determined based on at least one of a user contract, a user mission characteristic, a data size, or a data type.

6. The electronic device of claim 1, wherein, when executed by the processor, the instructions cause the electronic device to transfer data for the bundle processing that was suspended due to the deterioration of the space weather environment from the second storage to the processor, when the deterioration of the space weather environment is resolved.

7. The electronic device of claim 1, wherein the first storage and the second storage store, in bundle form, data that is transmitted to another electronic device via space communications.

8. The electronic device of claim 1, wherein the first storage has a relatively larger storage capacity per unit cost than that of the second storage.

9. The electronic device of claim 1, wherein the space weather environment is measured by a space weather sensor onboard a satellite that carries the electronic device.

10. The electronic device of claim 1, wherein the space weather environment is measured by a space weather forecasting alerting system located outside a satellite that carries the electronic device.

11. A method of operating an electronic device, the method comprising:
transferring data stored in a first storage to a second storage having a radiation tolerance higher than that of the first storage, when a deterioration of a space weather environment of a region of space in which the electronic device is located occurs; and
transferring data stored in the second storage to the first storage, when the deterioration of the space weather environment is resolved, and
wherein the data stored in the first storage or the data stored in the second storage is data that is transmitted to another electronic device via space communications in bundle form.

12. The method of claim 11, further comprising:
suspending bundle processing performed by a processor within the electronic device and transferring data being processed by the processor to the second storage, when the deterioration of the space weather environment occurs.

13. The method of claim 12, wherein the transferring data to the second storage further comprises:
entering a safe mode when the data stored in the first storage and the data being processed by the processor have been transferred to the second storage, due to the occurrence of the deterioration of the space weather environment.

14. The method of claim 11, wherein the transferring data to the second storage further comprises:
transferring the data stored in the first storage to the second storage in order of importance.

15. The method of claim 14, wherein the importance is determined based on at least one of a user contract, a user mission characteristic, a data size, or a data type.

16. The method of claim 11, further comprising:
transferring data for the bundle processing that was suspended due to the deterioration of the space weather environment from the second storage to the processor within the electronic device when the deterioration of the space weather environment is resolved.

17. The method of claim 11, wherein the first storage and the second storage store, in bundle form, data that is transmitted to another electronic device via space communications.

18. The method of claim 11, wherein the first storage has a relatively larger storage capacity per unit cost than that of the second storage.

19. The method of claim 11, wherein the space weather environment is measured by a space weather sensor onboard a satellite that carries the electronic device, or is measured by a space weather forecasting alerting system located outside the satellite that carries the electronic device.

20. A computer-readable recording medium having instructions stored thereon, wherein, when executed by a computer, the instructions cause the computer to perform each operation included in the method according to claim 11.
